(19) United States
(12) Patent Application Publication
(10) Pub. No.: US 2018/0185888 A1
(43) Pub. Date: Jul. 5, 2018

(54) SOLVENT VAPOR PHASE DEGREASING AND DEFLUXING COMPOSITIONS, METHODS, DEVICES AND SYSTEMS

(71) Applicant: HONEYWELL INTERNATIONAL INC., Morris Plains, NJ (US)

(72) Inventors: Rajat S. Basu, East Amherst, NY (US); Ryan Hulse, Getzville, NY (US); Jeffrey Beard, Avon, IN (US); Carlos Roberto Cedeno, Lockport, NY (US); Hannelore Rittinger, Morristown, NJ (US); Eric Borgstedt, Avvandale, NJ (US)

(21) Appl. No.: 15/905,111

(22) Filed: Feb. 26, 2018

Related U.S. Application Data
(63) Continuation of application No. 14/678,322, filed on Apr. 3, 2015.
(60) Provisional application No. 61/978,271, filed on Apr. 11, 2014.
(60) Provisional application No. 62/110,037, filed on Jan. 30, 2015.

(51) Int. Cl. B08B 3/10; C11D 7/50

(52) U.S. Cl. CPC B08B 3/106; C11D 7/5018

(57) ABSTRACT

The present invention relates, in part, to compositions that include (1) a first component comprising an alcohol, (b) a second component selected from the group consisting of a glycol ether, a terpene, a halogenated hydrocarbon, and combinations thereof, (c) a third component selected from the group consisting of a hydrohaloether, a decahalopentane, and combinations thereof.

### CROSS REFERENCE TO RELATED APPLICATIONS

This application is a continuation of U.S. application Ser. No. 14/678,322 filed Apr. 3, 2015 (now pending) which application claims the benefit of co-pending Provisional patent applications serial No. 61/978,278 filed Apr. 11, 2014 and 62/110,037 filed Jan. 30, 2015, each of which are incorporated herein by reference.

### FIELD OF THE INVENTION

The present invention relates, generally, to compositions, particularly solvent or cleaning compositions, for vapor phase degreasing and defluxing of substrate materials, and to solvent cleaning methods, devices and systems.

### BACKGROUND OF THE INVENTION

Solvent vapor phase degreasing and defluxing is a process of immersing a soiled substrate (e.g., a printed circuit board or a fabricated metal, glass, ceramic, plastic, or elastomer part or composite) into a boiling liquid such as certain chlorocarbon or chlorofluorocarbon fluids or admixtures, followed by rinsing the part in a second tank or cleaning zone by immersion or distillate spray with a clean solvent which is the same chlorocarbon or chlorofluorocarbon as used in the first cleaning zone. The parts are then dried by maintaining the cooled part in the condensing vapors until temperature has reached equilibrium.

Solvent cleaning of various types of parts generally occurs in batch, hoist-assisted batch, conveyor batch, or in-line type conveyor degreaser and defluxer equipment. Such in-line conveyor degreaser and defluxer equipment are disclosed in U.S. Pat. No. 5,007,179 (entitled “Cold Air Lock Vapor Seal”), commonly assigned to the assignee of the present invention. Parts may also be cleaned in open top defluxing or degreasing equipment, such as that disclosed in U.S. patent application Ser. No. 07/587,893, filed Sep. 25, 1990, now U.S. Pat. No. 5,075,982, also commonly assigned. In both types of equipment, the entrance and/or exit ends of the equipment are generally in open communication with both the ambient environment and the solvent within the equipment. In order to minimize the loss of solvent from the equipment by either convection or diffusion, a common practice in the art is to use water-cooled or refrigerant-cooled coils which create a vapor blanket over a hot or ambient zone region in the degreaser/defluxer tank, such as disclosed in U.S. Pat. No. 4,261,111 to Rand, which is incorporated herein by reference.

Therefore, in the foregoing solvent vapor phase degreasing process, it is generally known to use a single organic chlorocarbon or chlorofluorocarbon (CFC) fluid to perform the cleaning, rinsing, and drying steps. The use of CFC-113 and Freon type solvents have been, in the past, particularly popular. However, the vapor diffusion thereof into the environment has been implicated to be one of many possible contributing causes to the undesirable global depletion of stratospheric ozone.

In response to environmental concern, certain hydrochlorofluorocarbon (HCFC) based solvents have been developed to provide more environmentally acceptable alternatives to CFC based vapor phase degreasing and defluxing processes. While these materials have been shown to be excellent substitutes for previously used CFC materials in a variety of cleaning applications, they are considered to be only an interim replacement to those CFCs. This is due, in large part, to the fact that the proposed materials still possess a small, but finite, ozone depletion potential, although it is much lower than that of the CFCs which they are replacing. Hence, these certain HCFC solvents are also proposed for global phaseout in the near future. It is generally believed that organic solvents which do not contain chlorine, bromine, or iodine atoms will have a tendancy to not contribute to stratospheric ozone depletion. However, many organic chemicals which do not contain the above halogen atoms, such as hydrocarbons, alcohols, esters, ethers, ketones, etc., will sometimes contain undesirable flammability or reactivity properties. Furthermore, certain perfluorinated, saturated hydrocarbons and hydrofluorocarbons are known to possess many desirable solvent properties, such as: zero ozone depletion potential; stable, non-reactive, high compatibility with plastics; good water displacement potential; generally non-toxic and inert, and ideally suited to vapor phase solvent cleaning equipment. However, many of such perfluorocarbons have been found to be very poor solvents for many common organic and inorganic soils, e.g., fluxes. While certain hydrofluorocarbons may offer improved but still limited cleaning ability over perfluorocarbons, it has been a concern that such materials will to exhibit undesirable flammability properties comparable to their hydrocarbon analogs.

European Patent Publication 0 431 458 published Jun. 12, 1991 teaches aliphatic hydrofluorocarbons of the formula CₙFₘH₂ₙ₊₂₋ₘ wherein 4≤n≤6 and 6≤m≤12 which are useful as cleaning compositions. The reference teaches that the aliphatic hydrofluorocarbon is the active component in the removal of the fluxes, fats and oils, and dust from soiled parts. The reference teaches that in order to increase the solvency for dissolving fluxes, an organic solvent selected from hydrocarbons, alcohols, esters, and ketones may be added in various amounts to the aliphatic hydrofluorocarbon.

Other types of cleaning processes such as aqueous cleaning exist. Aqueous cleaning generally involves the cleaning of a substrate or a part in an aqueous solution of detergents or surfactants, followed by multiple rinsing steps with purified water. The part is then dried by lengthy evaporation in air or by energy intensive thermal drying machines. This process is not always desirable due to the high energy cost for drying and the additional capital investment and operating cost burden to provide aqueous waste water cleanup required by state and local authorities before sewering to ground water.

Another cleaning process, semi-aqueous cleaning, consists of cleaning a substrate in a hydrocarbon solvent based on, for example, terpenes, esters, or petroleum distillates having a high affinity for oils, waxes, and greases being cleaned from the parts, with or without the aid of a surfactant. The cleaned substrate is rinsed in the high boiling hydrocarbon solvent with multiple rinsing steps using purified water. The hydrocarbon solvent is phase separated back to the wash sump while the aqueous effluent must be processed before sewering to ground water. Consequently, high costs associated with drying energy and with processing waste effluent are evident, similar to the before-mentioned aqueous cleaning process. A further drawback is that the hydrocarbon solvent usually possesses a flash point and this must be carefully handled or blanketed with a nonflammable compressed gas such as nitrogen to avoid explosion. Nitrogen gas is much more fugitive than the dense vapors of a fluorocarbon contained in a condensing zone. Furthermore, in a number of applications, while the substrate to be cleaned may be compatible with the hydrocarbon solvent, some plastics or metals may be incompatible with the aqueous rinse solvent, resulting in water absorption or rusting of the substrate.

### SUMMARY

In a first aspect of the invention, solvent cleaning compositions are provided that include (a) a first component comprising an alcohol selected from the group consisting of methanol, ethanol and isopropanol, (b) a second component selected from the group consisting of a glycol ether, a terpene, a halogenated hydrocarbon, and combinations thereof, and (c) a third component selected from the group consisting of a hydrofluorocarbon (other than the halogenated hydrocarbon second component), a hydrohaloether, a decahalopentane, and combinations thereof, wherein the second and third components are not the same. In further aspects, the third component is provided in an amount effective to form an azeotrope or azeotrope-like composition with at least one alcohol of the first component.

In certain embodiments of this first aspect of the invention, the second component (b) includes a halogenated hydrocarbon, which preferably is provided in the relative amounts described herein. The halogenated hydrocarbon preferably includes compounds comprised of from one (1) to ten (10) carbon atoms, preferably comprising or in some embodiments consisting of C₁ to C₈ alkyl groups, C₁ to C₈ alkenyl groups, C₁ to C₈ alcohol groups, C₁ to C₁₀ ethers, and C₅ to C₇ cyclic alkenyl groups, which compounds are substituted with at least one halogen selected from F, Cl, Br, or I. In certain embodiments, the halogenated hydrocarbon is substituted with at least one Cl. In certain preferred embodiments, the halogenated hydrocarbon comprises, consists essentially of or consists of trans-1,2-dichloroethylene, perchloroethylene, trichloroethylene, and combinations thereof.

In certain embodiments of the first aspect of the invention, the second component (b) includes a glycol ether, which preferably is provided in the amounts described herein. The glycol ether in preferred embodiments includes the structure R′O—R—OR′, where R is selected from a C₁ to C₈ alkyl group, a C₁ to C₈ alkenyl group, a C₁ to C₈ alcohol group, a C₁ to C₁₀ ether group, a C₅ to C₇ cyclic alkyl group, a C₅ to C₇ cyclic alkenyl group, a C₅ to C₇ heterocyclic alkyl group, and a C₅ to C₇ heterocyclic alkenyl group, and each R′ is independently selected from H, a C₁ to C₈ alkyl group, a C₁ to C₈ alkenyl group, a C₁ to C₈ alcohol group, or a C₁ to C₁₀ ether group, a C₅ to C₇ cyclic alkyl group, a C₅ to C₇ cyclic alkenyl group, a C₅ to C₇ heterocyclic alkyl group, and a C₅ to C₇ heterocyclic alkenyl group. In certain embodiments, R is a C₁-C₄ alkyl group. In further embodiments, the glycol ether is a compound according to the structure R′—O—(CH₂)₂—O—R′, where at least one R′ is H and the other R′ is selected from the group consisting of a C₁ to C₈ alkyl group, a C₁ to C₈ alkenyl group, a C₁ to C₈ alcohol group, a C₁ to C₁₀ ether, and a C₅ to C₇ cyclic alkenyl group. In even further embodiments, the glycol ether is selected from the group consisting of ethylene glycol monobutyl ether, 2-ethoxyethanol, 2-methoxyethanol, 2-propxyethanol, 2-phenoxyethanol, 2-benzoxy ethanol, methyl carbitol, carbitol cello solve, diethoxyethane, dimethoxyethane, dibutoxybutane, dipropylene glycol methyl ether, dipropylene glycol mono n-butyl ether, dipropylene glycol monomethyl ether acetate, propylene glycol monomethyl ether, propylene glycol monomethyl ether acetate, and/or propylene glycol phenyl ether.

In certain embodiments of the first aspect of the invention, the second component includes a terpene, which is preferably provided in the amounts disclosed herein. While the terpene may be any of or combination of terpenes provided herein, in certain aspects the terpene comprises, consists essentially of or consists of s d-Limonene and/or pinene.

In certain embodiments of the first aspect of the invention, the third component preferably comprises a hydrohaloether. In certain aspects, the hydrohaloether has the structure R—O—R′, wherein R and R′ are each independently selected from the group consisting of a C₁ to C₂₀ alkyl group, C₁ to C₂₀ alkenyl group, C₁ to C₂₀ alcohol group, C₁ to C₂₀ ether group, C₅ to C₇ cyclic alkyl group, C₅ to C₇ cyclic alkenyl group, C₅ to C₇ heterocyclic alkyl group, and C₅ to C₇ heterocyclic alkenyl group, where at least one of R and/or R′ is substituted at one or more positions with a halogen atom. In certain preferred embodiments, the hydrohaloether is a hydrofluoroether, wherein in certain embodiments it has or includes the structure CH₂OCF₂CF₂CF₂CF₃. Preferably the third component, including and preferably the hydrohaloether component, is present in the composition in an amount from about 25 weight percent to about 99 weight percent, in certain embodiments, in an amount from about 50 weight percent to about 99 weight percent, in certain embodiments in an amount from about 75 weight percent to about 99 weight percent, in certain embodiments in an amount from about 90 weight percent to about 99 weight percent, and in certain embodiments in an amount from about 92 weight percent to about 96 weight percent, based on the total of components (a), (b) and (c) of the composition.

In certain embodiments of the first aspect of the invention, the third component preferably includes a decahalopentane, which in certain preferred embodiments is a decafluoropentane. The decafluoropentane in preferred embodiments comprises, consists essentially of or is selected from the group consisting of 1,1,1,2,3,4,4,5,5,5-decafluoropentane, 1,1,1,2,2,3,4,5,5,5-decafluoropentane, and/or 1,1,1,2,3,3,4,5,5,5-decafluoropentane. The decahalopentane is preferably provided in an amount from about 30 weight percent to about 99 weight percent, in certain embodiments, in an amount from about 50 weight percent to about 99 weight percent, in certain embodiments in an amount from about 70 weight percent to about 99 weight percent, in certain embodiments in an amount from about 90 weight percent to about 99 weight percent, and in certain embodiments in an amount from about 92 weight percent to about 96 weight percent, based on the total of components (a), (b) and (c) of the composition.

In a second aspect of the invention, solvent cleaning compositions are provided that include (i) 1-chloro-3,3,3-trifluorpropene and (ii) at least one second component that is the same as the second component of the first aspect and is present in the same concentration as described in connection with the first aspect. In certain embodiments of this second aspect, component (i) comprises an azeotrope or azeotrope-like composition consisting essentially of 1-chloro-3,3,3-trifluorpropene and an alcohol selected from the group consisting of methanol, ethanol and isopropanol, and in such embodiments it is preferred that the components (i) and (ii) do not form a separate azeotrope.

The compositions of the present invention may be used in sprayable compositions, solvents, or aerosols. In certain non-limiting aspects, such compositions may be used in methods for removing residual soils or surface contamination from a part. Such a method may include immersing the part in a solvent composition of the present invention. In certain embodiments, it is preferred to provide a solvent composition of the invention and then heat the composition to form a flammability-suppression blanket comprising component (a) or (i) and a substantial absence of the second component (b). The part is then preferably dried within the flammability-suppression blanket.

As used herein, the term flammability-suppression blanket means a vapor space that contains gases which have no flame limit as measured according to ASTM E-681-09, which is incorporated herein by reference.

To assist in the formation of the vapor blanket, the second component may have a boiling point that is at least 10° C. higher, in certain aspects at least 25° C. higher, and in further aspects at least 50° C. higher than: (1) in the case of the first aspect, the first and third components (a) and (c) and/or any azeotrope or azeotrope-like compositions formed therebetween; and (2) in the case of the second aspect component (i), namely the 1-chloro-3,3,3-trifluoropropene and/or any azeotrope or azeotrope-like compositions formed between 1-chloro-3,3,3-trifluoropropene and an alcohol if present (particularly methanol, ethanol, and isopropanol).

Additional embodiments and advantages to the invention will be readily apparent on the basis of the disclosure provided.

### BRIEF DESCRIPTION OF THE FIGURES

FIG. 1 illustrates a partial schematic view of degreasing or defluxing equipment that may be used in one embodiment of the present invention.

### DETAILED DESCRIPTION

According to certain embodiments of the first aspect of the present invention, the preferred compositions, particularly solvent or cleaning compositions, include (a) a first component consisting essentially of or consisting of or more alcohols, (b) a second component selected from the group consisting a glycol ether, a terpene, and/or a halgenated hydrocarbon (other than a decahalopentane), and (c) a third component selected from the group consisiting a hydrofluorocarbon, a halogenated ether and/or a decahalopentane, wherein the second (b) and third components (b) are not the same. In certain aspects, the second component(s) (b) is a solvent that has a boiling point that is greater than that of either the first (a) or third (c) components. In further aspects, the second component (b) does not form an azeotrope or azeotrope-like composition (or is provided in amounts to not form an azeotrope or azeotrope-like composition) with either or both of the first (a) and third (c) components.

In certain embodiments of the second aspect of the present invention, the compositions, particularly solvent or cleaning compositions, preferably include a first component of 1-chloro-3,3,3-trifluoropropene (HCFO-1233zd) alone or as an azeotrope or azeotrope-like composition with an alcohol, and a second component (b) as described herein in connection with the first aspect. In such embodiments, it is preferred that the second component (b) is a solvent that has a boiling point that is greater than that of the HCFO-1233zd included in the composition, whether cis or trans isomers or combinations thereof, or any azeotropic or azeotrope-like composition that forms between HCFO-1233zd and the alcohol(s) as described herein. In further aspects, the second component (b) does not form an azeotrope or azeotrope-like composition (or is provided in amounts to not form an azeotrope or azeotrope-like composition) with HCFO-1233zd and/or the alcohol.

The compositions of the invention are advantageous, inter alia, as solvents for the removal of unwanted debris from a substrate, such as the removal of solder flux or other residue from printed circuit boards or petroleum, synthetic or semi-snythetic based oil or grease from a metallic or nonmetallic part. In particular, such compositions are advantageous for use in vapor degreasing machines (particularly multi-sump machines), as a cold cleaner or as a spray, e.g. an aerosol spray.

Components

Component (a) and Component (i)

The term “HCFO-1233zd” refers to the compound 1-chloro-3,3,3-trifluoropropene, independent of whether it is the cis- or trans-form. The terms “cis-HCFO-1233zd” and “trans-HCFO-1233zd” are used to describe the cis- and trans-forms of 1-chloro-3,3,3-trifluoropropene, respectively. The term “HCFO-1233zd” therefore includes within its scope cis-HFCO-1233zd, trans-HCFO-1233zd, and all combinations and mixtures of these.

The term “cis-HCFO-1233zd” means that the amount cis-HCFO-1233zd relative to all isomers of HCFO-1233zd is at least about 95%, more preferably at least about 98%, even more preferably at least about 99%, even more preferably at least about 99.9%. In certain preferred embodiments, the cis-HCFO-1233zd component is essentially pure cis-HCFO-1233zd.

The term “trans-HCFO-1233zd” means that the amount of trans-HCFO-1233zd relative to all isomers of HCFO-1233zd is at least about 95%, more preferably at least about 98%, even more preferably at least about 99%, even more preferably at least about 99.9%. In certain preferred embodiments, the trans-HCFO-1233zd component is essentially pure trans-HCFO-1233zd.

The alcohol may refer to any component having an alcohol group attached thereto. In certain non-limiting embodiments, the alcohols include a C₁-C₃ alcohol, and in certain preferred embodiments the alcohol comprises at least one of methanol, ethanol, or isopropanol.

Component (b)

As used herein, the term “glycol ether” refers to compounds a class of solvents based on alkyl ethers of an alkylene glycol. In certain non-limiting aspects, it may be represented by Formula I having the structure R′O—R—OR′, where R is selected from a C₁ to C₈ alkyl group, C₁ to C₈ alkenyl group, C₁ to C₈ alcohol group, C₁ to C₁₀ ether group, C₅ to C₇ cyclic alkyl group, C₅ to C₇ cyclic alkenyl group, C₅ to C₇ heterocyclic alkyl group, or C₅ to C₇ heterocyclic alkenyl group, where any of the foregoing (if applicable) may be straight or branch chained and may be optionally substituted at one or more positions. Each R′ is independently selected from an H, a C₁ to C₈ alkyl group, a C₁ to C₈ alkenyl group, a C₁ to C₈ alcohol group, or a C₁ to C₁₀ ether group, a C₅ to C₇ cyclic alkyl group, a C₅ to C₇ cyclic alkenyl group, a C₅ to C₇ heterocyclic alkyl group, or a C₅ to C₇ heterocyclic alkenyl group, where any of the foregoing (if applicable) may be straight or branch chained and may be optionally substituted at one or more positions. In certain aspects, at least one R′ is not an H.

In certain embodiments of the foregoing, R is a C₁-C₅ straight or branch chained alkyl moiety and forms an alkylene glycol of an alkyl ether. In certain aspects, R is a C₂-C₄ straight or branch chained alkyl moiety. In event further embodiments of the foregoing, R is an ethyl moiety and forms an alkylene glycol of an ethylene ether and having the structure R′—O—(CH₂)₂—O—R′. Each R′ may be defined as indicated above. In certain aspects, it includes at least one C₁ to C₈ alkyl group, C₁ to C₈ alkenyl group, C₁ to C₈ alcohol group, C₁ to C₁₀ ether, or C₅ to C₇ cyclic alkenyl group, any of which may be straight or branched chained (if applicable) and/or optionally substituted at one or more positions. In even further embodiments, at least one R′ is H and the second R′ includes at least one C₁ to C₈ alkyl group, C₁ to C₈ alkenyl group, C₁ to C₈ alcohol group, C₁ to C₁₀ ether, or C₅ to C₇ cyclic alkenyl group, any of which may be straight or branched chained or optionally substituted at one or more positions. In certain preferred embodiment, the glycol ether is selected from one or a combination of the following: ethylene glycol monobutyl ether (also called “butyl cellosolve”), 2-ethoxyethanol (also known as “ethyl cellosolve”), 2-methoxyethanol, 2-propoxyethanol, 2-phenoxyethanol, 2-benzoxy ethanol, methyl carbitol, 2-(2-ethoxyethoxy)ethanol (also known as “carbitol cellosolve”), diethoxyethane, dimethoxyethane, dibutoxybutane, dipropylene glycol methyl ether, dipropylene glycol mono n-butyl ether, dipropylene glycol monomethyl ether acetate, propylene glycol monomethyl ether, propylene glycol monomethyl ether acetate, and/or propylene glycol phenyl ether.

As used herein, the term “terpene” means a compound, which is comprised of at least ten carbon atoms and contains at least one, and preferably at least two isoprene moieties. In many preferred embodiments, the terpene compound of the present invention is formed from the reaction of at least two isoprene C₅ units (CH₂═C(CH₃)—CH═CH₂) (each unit being substituted or unsubstituted), and thus many of the terpene compounds of the present invention preferably have as at least 10 carbon atoms and include at least one isoprene moiety. As used herein, the term “isoprene moiety” refers to any portion of a molecule, which includes a radical, which can be formed from substituted or unsubstituted isoprene. In certain preferred embodiments, unsubstituted terpenes are preferred.

In many preferred embodiments, the terpene compound of the present invention comprises at least one head-to-tail condensation product of modified or unmodified isoprene molecules. It is contemplated that any one or more terpene compounds are adaptable for use in accordance with the present invention and that those skilled in the art will be able, in view of the teachings contained herein, to select the number and type of terpene compound(s) for any particular application without undue experimentation. The preferred terpenes of the present invention are hydrocarbons having molecular formula (C₅H₈)ₙ in a cyclic or acyclic, saturated or unsaturated, substituted or unsubstituted structure, with n preferably being from 2 to about 6, and even more preferably 2 to 4. Terpenes according to the present invention having the formula C₁₀H₁₆ (including substituted forms) are sometimes referred to herein as monoterpenes, while terpenes having the formula C₁₅H₂₄ (including substituted forms) are sometimes referred to herein as sesquiterpenes. Terpenes according to the present invention having the formula C₂₀H₃₂ (including substituted forms) are sometimes referred to herein as diterpenes, while terpenes having the formula C₃₀H₂₄ (including substituted forms) are sometimes referred to as triterpenes, and so on. Terpenes containing 30 or more carbons are usually formed by the fusion of two terpene precursors in a regular pattern. While it is contemplated that all such terpenes are adaptable for use in accordance with the present invention, the use of monoterpenes is generally preferred.

In certain preferred embodiments, the terpene compound(s) of present compositions comprise, preferably in major proportion, and even more preferably consist essentially of, one or more acyclic terpene compounds. Among the acyclic terpenes, it is contemplated that such compounds may be within the class of compounds identified as head-to-tail linked isoprenoids or within the class of compounds that are not joined in that manner. Acyclic terpenes which are preferred for use in accordance with certain aspects of the present invention include myrcene (2-methyl-6-methyleneocta-1,7-diene), allo-cimene, beta-ocimene.

In certain embodiments, the terpene compounds of the present invention may comprise cyclic terpene compounds. Among the cyclic terpenes, mono-, bi-, tri-, or tetracyclic compounds having varying degrees of unsaturation are contemplated for use in accordance with the present invention. In certain preferred embodiments, the terpene is a cyclic terpene compound having the formula 1-methyl-4-isopropenyl-1-cyclohexene also called “d-Limonene,” which has the following structure.

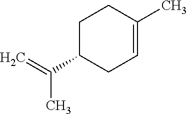

In certain preferred embodiments, the terpene is a cyclic terpene compound comprising pinene, which may have the following chemical structure:

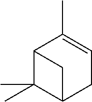

Examples of terpene compounds adaptable for use in connection with the various aspects of the present invention include terebene, myrcene, limonene, retinal, pinene, menthol, geraniol, farnesol, phytol, terpinene, delta-3 carene, terpinolene, terpineol, linaleol, camphene, phellandrene, fenchene, and the like, as well as blends thereof, including all their isomers.

Other examples of terpene derivatives in accordance with the present invention include oxygen-containing derivatives of terpenes such as alcohols, aldehydes or ketones containing hydroxyl groups or carbonyl groups, as well as hydrogenated derivates. Oxygen-containing derivatives of terpenes are sometimes referred to herein as terpenoids. In certain embodiments, the diene-based compounds of the present invention comprise the terpenoid Carnosic acid. Carnosic acid is a phenolic diterpene that corresponds to the empirical formula C₂₀H₂₈O₄. It occurs naturally in plants of the Libiatae family. For instance, carnosic acid is a constituent of the species Salvia officinalis (sage) and Rosmarinus officinalis (rosemary) where it is mainly found in the leaves. Carnosic acid is also found in thyme and marjoram (see Linde in Salvia officinalis [Helv. Chim Acta 47, 1234 (1962)] and Wenkert et al. in Rosmarinus officinalis [J. Org. Chem. 30, 2931 (1965)], and in various other species of sage, (see Salvia canariensis [Savona and Bruno, J. Nat. Prod. 46, 594 (1983)] and Salvia willeana [de la Torre et al., Phytochemistry 29, 668 (1990)]). It is also present in Salvia triloba and Salvia sclarea. Other potential terpenoids are illustrated below:

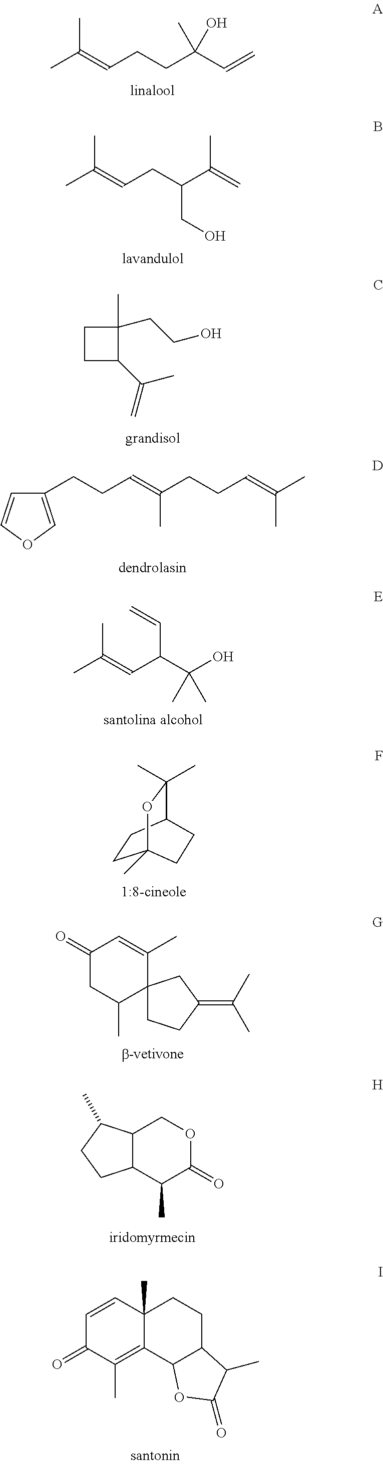

As used herein, the term “halogenated hydrocarbons” refers to a hydrocarbon chain or ring where at least one position is substituted with a halogen atom. The hydrocarbon chain may include a C₁ to C₂₀ alkyl group, a C₁ to C₂₀ alkenyl group, a C₁ to C₂₀ alcohol group, a C₁ to C₂₀ ether, a C₅ to C₇ cyclic alkenyl group, a C₅ to C₇ heterocyclic alkyl group, or C₅ to C₇ heterocyclic alkenyl group, any of which may be straight or branched chained (if applicable) and/or optionally substituted at one or more positions. In certain aspects, it includes a C₁ to C₈ alkyl group, a C₁ to C₈ alkenyl group, a C₁ to C₈ alcohol group, a C₁ to C₁₀ ether, or a C₅ to C₇ cyclic alkenyl group, any of which may be straight or branched chained (if applicable) and/or optionally substituted at one or more positions. In any of the foregoing embodiments, the hydrocarbon is preferably substituted with at least one halogen selected from F, Cl, Br, or I.

In certain embodiments, the halogenated hydrocarbon is a C₁ to C₅ alkyl group or a C₁ to C₅ alkenyl group. In further embodiments, it is a C₂ alkenyl group that contains at least one chlorine atom. Non-limiting examples of such solvents include, trans-1,2-dichloroethylene, perchloroethylene, trichloroethylene, and combinations thereof. In certain aspects, the halogenated hydrocarbon used as the second component does not include a decahalopentane, particularly a decafluoropentane.

Component (c)

The descriptions above regarding the halogentated hydrocarbon are applicable equally to the hydrofluoroolefin of component (c), provided that at least on F substituent is present in the compound.

As used herein, a hydrohaloether refers to a class of solvents having the structure R—O—R′. R and R′ may be independently is selected from a C1 to C20 alkyl group, C1 to C20 alkenyl group, C1 to C20 alcohol group, C1 to C20 ether group, C5 to C7 cyclic alkyl group, C5 to C7 cyclic alkenyl group, C5 to C7 heterocyclic alkyl group, or C5 to C7 heterocyclic alkenyl group, where any of the foregoing (if applicable) may be straight or branch chained and at least one group is substituted at one or more positions with a halogen atom.

In certain preferred embodiments, the hydrohaloether is a hydrofluoroether, which may include monomic or polymerized structures in accordance with the foregoing, where one or more of the R or R′ substituent groups is substituted with a fluorine atom. In certain non-limiting embodiments the hydrofluoroether includes at least one nonafluoro alkyl ether, wherein the alkyl may include 1-10 carbon atoms. In certain non-limiting embodiments, the nonafluoro alkyl ether includes a nonafluor butyl ether and/or a nonafluoro isobutyl ether, including, but not limited to, those commercially available under the tradename NOVEC®, particularly though not exclusively NOVEC® 7200 (available from 3M). In certain non-limiting embodiments, the hydrohaloether has or otherwise includes the following structure CH3OCF2CF2CF2CF3¬¬, (CF3)2CFCF2OCH3, CH3OCF2CF2CF3 or any combination of these with trans-1,2-dichloroethylene.

As used herein, a “decahalopentane” means a five carbon alkyl chain substituted with 10 halogen atoms, which may be selected from F, Cl, Br, or I. In certain preferred embodiments, the decahalopentane is a decafluoropentane. Non-limiting examples of such a compound include 1,1,1,2,3,4,4,5,5,5-decafluoropentane, 1,1,1,2,2,3,4,5,5,5-decafluoropentane, and/or 1,1,1,2,3,3,4,5,5,5-decafluoropentane. In certain embodiments, the decahalopentane or decafluoropentane includes at least one such compound commercially available under the tradename VERTREL® (available from DuPont), including, but not limited to, VERTREL SFR and/or VERTREL XF.

Component Amounts

Applicants believe that those skilled in the art, based upon the teachings and examples contained herein, will be able to select various relative amounts of the components of the present compositions, whether in the first aspect or the second aspect of the invention, according to the needs of the particular application. Nevertheless, applicants believe that the relative amounts of the various components as described below will be preferred in many applications.

The alcohol(s) provided in the first component (a) or as part of component (i) are preferably collectively provided in an amount from greater than about 0 weight percent to about 15 weight percent, based on the total weight of the composition. In certain aspects, the alcohol(s) is provided in an amount from about 0.01 weight percent to about 10 weight percent, based on the total weight of the composition. In certain preferred embodiments, the alcohol(s) is provided in an amount from about 1 weight percent to about 5 weight percent, based on the total weight of the composition.

The second component (b), including particularly glycol ether, when used in the second component (b), is preferably provided in an amount from greater than about 0 weight percent to about 30 weight percent, based on the total weight of the composition. In certain preferred embodiments, the second component, including particularly glycol ether, is provided in an amount from about 0.01 weight percent to about 25 weight percent, based on the total weight of the composition. In certain preferred embodiments, depending upon the third component used, the second component, including particularly glycol ether, is provided in an amount from about 1 weight percent to about 20 weight percent, based on the total weight of the composition.

For second aspects of the invention involving component (i), when present glycol ether is preferably provided in an amount from about 0.01 weight percent to about 30 weight percent, more preferably from about 0.05 weight percent to about 10 weight percent, and even more preferably from about 1 weight percent to about 5 weight percent based on the total weight of the composition. In such embodiments, component (i) is preferably provided in amounts from about 70 weight percent to about 99.99 weight percent, more preferably from about 90 weight percent to about 99.95 weight percent, and even more preferably from about 95 weight percent to about 99 weight percent, based on the total weight of the composition

When the second component (b) comprises a terpene, it is preferably provided in an amount from greater than about 0 weight percent to about 30 weight percent, based on the total weight of the composition. In certain preferred embodiments, the terpene is provided in an amount from about 0.01 weight percent to about 25 weight percent, based on the total weight of the composition. In certain preferred embodiments, the terpene is provided in an amount from about 1 weight percent to about 20 weight percent, based on the total weight of the composition.

For second aspects of the invention involving component (i), when present terpene(s) is preferably provided in an amount from about 0.01 weight percent to about 30 weight percent, more preferably from about 0.05 weight percent to about 10 weight percent, and even more preferably from about 1 weight percent to about 5 weight percent based on the total weight of the composition. In such embodiments, component (i) is preferably provided in amounts from about 70 weight percent to about 99.99 weight percent, more preferably from about 90 weight percent to about 99.95 weight percent, and even more preferably from about 95 weight percent to about 99 weight percent, based on the total weight of the composition

When the second component (b) comprises a halogenated hydrocarbon, it may be provided in an amount from greater than about 0 weight percent to about 50 weight percent, from about 0.01 weight percent to about 40 weight percent, or from about 1 weight percent to about 30 weight percent, based on the total weight of the composition.

For second aspects of the invention involving component (i), when present halogenated hydrocarbon is preferably provided in an amount from about 0.01 weight percent to about 95 weight percent, more preferably from about 0.01 weight percent to about 80 weight percent, and even more preferably from about 1 weight percent to about 50 weight percent, and in certain embodiments from about 1 weight percent to about 30 weight percent based on the total weight of the composition. In such embodiments, component (i) is preferably provided in amounts from about 5 weight percent to about 99.99 weight percent, more preferably from about 20 weight percent to about 99.99 weight percent, and even more preferably from about 50 weight percent to about 99 weight percent, based on the total weight of the composition.

When the second component (b) is trans-1,2-dichloroethylene, it is preferably provided in an any amount from about 1 to about 99%, from greater than about 5 weight percent to about 50 weight percent, from about 6 weight percent to about 30 weight percent, and in certain embodiments from about 6 weight percent to about 20 weight percent, based on the total weight of the composition. In certain preferred embodiments, the trans-1,2-dichloroethylene is provided in an amount from about 6 weight percent to about 35 weight percent, based on the total weight of the composition.

For second aspects of the invention involving component (i), when present trans-1,2,-dichloroethylene is preferably provided in an amount from about 5 weight percent to about 95 weight percent, more preferably from about 6 weight percent to about 95 weight percent, and even more preferably from about 6 weight percent to about 80 weight percent, even more preferably in certain embodiments from about 6 weight percent to about 50 weight percent, and in certain embodiments from about 6 weight percent to about 25 weight percent, based on the total weight of the composition. In such embodiments, component (i) is preferably provided in amounts from about 5 weight percent to about 95 weight percent, more preferably from about 5 weight percent to about 94 weight percent, even more preferably from about 20 weight percent to about 94 weight percent, and in certain embodiments from about 50 weight percent to about 94 weight percent, based on the total weight of the composition.

In certain aspects, such third components (c) are provided in an amount from greater than 0.01 weight percent to about 99 weight percent, based on the total weight of the composition. In certain aspects, the third component is provided in an amount from about 25 weight percent to about 99 weight percent, or in certain embodiments from about 20 weight percent to about 99 weight percent, based on the total weight of the composition. In certain preferred embodiments, the third component (c) is provided in an amount from about 50 weight percent to about 99 weight percent, based on the total weight of the composition. In certain preferred embodiments, the third component is provided in an amount from about 70 weight percent to about 99 weight percent, or the third component is provided in an amount from about 75 weight percent to about 99 weight percent, based on the total weight of the composition. In even further embodiments, the third component is provided in an amount from about 90 weight percent to about 99 weight percent, and in certain embodiments the third component is provided in an amount from about 92 weight percent to about 96 weight percent, based on the total weight of the composition.

Azeotropic and Azeotrope-Like Compositions

In certain embodiments, the first component (a) and third components (c) form azeotrope-like compositions, or the first component (i) comprises an azeotrope or azeotrope-like composition. As used herein, the term “azeotrope-like” relates to compositionsthat are strictly azeotropic or that generally behave like azeotropic mixtures. An azeotropic mixture is a system of two or more components in which the liquid composition and vapor composition are equal at the stated pressure and temperature. In practice, this means that the components of an azeotropic mixture are constant-boiling or essentially constant-boiling and generally cannot be thermodynamically separated during a phase change. The vapor composition formed by boiling or evaporation of an azeotropic mixture is identical, or substantially identical, to the original liquid composition. Thus, the concentration of components in the liquid and vapor phases of azeotrope-like compositions change only minimally, if at all, as the composition boils or otherwise evaporates. In contrast, boiling or evaporating non-azeotropic mixtures changes the component concentrations in the liquid phase to a significant degree.

As used herein, the term “consisting essentially of,” with respect to the components of an azeotrope-like composition, means the composition contains the indicated components in an azeotrope-like ratio, and may contain additional components provided that the additional components do not form new azeotrope-like systems. For example, azeotrope-like mixtures consisting essentially of two compounds are those that form binary azeotropes, which optionally may include one or more additional components, provided that the additional components do not render the mixture non-azeotropic and do not form an azeotrope with either or both of the compounds.

The term “effective amounts” as used herein to refer to the azeotropic compositions means the amount of each component which, upon combination with the other components, results in the formation of an azeotrope or azeotrope-like composition of the present invention.

As used herein, the term “ambient pressure” with respect to boiling point data means the atmospheric pressure surrounding the relevant medium. In general, ambient pressure is 14.7 psia, but could vary+/−0.5 psi.

The azeotrope-like compositions of the present invention can be produced by combining effective amounts of HFO-1233zd with one or more alcohols, preferably in fluid form. Any of a wide variety of methods known in the art for combining two or more components to form a composition can be adapted for use in the present methods. For example, HFO-1233zd and the alcohol can be mixed, blended, or otherwise combined by hand and/or by machine, as part of a batch or continuous reaction and/or process, or via combinations of two or more such steps. In light of the disclosure herein, those of skill in the art will be readily able to prepare azeotrope-like compositions according to the present invention without undue experimentation.

In a preferred embodiments, the azeotrope-like composition comprises effective amounts of HFO-1233zd and a C1-C3 alcohol. Preferably, the C1-C3 alcohol is selected from the group consisting of methanol, ethanol, and isopropanol. Non-limiting examples of such azeotropes are provided in U.S. Pat. No. 8,163,196, the contents of which are incorporated herein by reference in its entirety. In certain preferred embodiments, HFO-1233zd is the trans isomer.

In certain embodiments, the azeotrope-like composition comprises effective amounts of trans-HFO-1233zd and methanol. These binary azeotrope-like compositions may consist essentially of about 70 to about 99.95 wt. % trans-HFO-1233zd and from about 0.05 to about 30 wt. % methanol, more preferably from about 90 to about 99.95 wt. % trans-HFO-1233zd and about 0.05 to about 10 wt. % methanol, and even more preferably from about 95 to about 99.95 wt. % trans-HFO-1233zd and from about 0.05 to about 5 wt. % methanol. In certain aspects, such trans-HFO-1233zd/methanol compositions have a boiling point of from about 17° C. to about 19° C., more preferably about 17° C. to about 18° C., even more preferably about 17° C. to about 17.5° C., and most preferably about 17.15° C.±1° C., all measured at ambient pressure.

In certain embodiments, the azeotrope-like composition comprises effective amounts of cis-HFO-1233zd and methanol. These binary azeotrope-like compositions consist essentially of about 78 to about 99.9 wt. % cis-HFO-1233zd and from about 0.1 to about 22 wt. % methanol, more preferably from about 85 to about 99.9 wt. % cis-HFO-1233zd and about 0.1 to about 15 wt. % methanol, and even more preferably from about 88 to about 99.5 wt. % cis-HFO-1233zd and from about 0.5 to about 12 wt. % methanol. In certain aspects, such cis-HFO-1233zd/methanol compositions have a boiling point of about 35.2±1° C. at ambient pressure.

In further embodiments, the azeotrope-like composition comprises effective amounts of trans-HFO-1233zd and ethanol. These binary azeotrope-like compositions may consist essentially of about 85 to about 99.9 wt. % trans-HFO-1233zd and from about 0.1 to about 15 wt. % ethanol, more preferably from about 92 to about 99.9 wt. % trans-HFO-1233zd and about 0.1 to about 8 wt. % ethanol, and even more preferably from about 96 to about 99.9 wt. % trans-HFO-1233zd and from about 0.1 to about 4 wt. % ethanol. In certain aspects, such trans-HFO-1233zd/ethanol compositions have a normal boiling point of about 18.1° C.±1° C. at ambient pressure.

In further embodiments, the azeotrope-like composition comprises effective amounts of cis-HFO-1233zd and ethanol. These binary azeotrope-like compositions may consist essentially of about 65 to about 99.9 wt. % cis-HFO-1233zd and from about 0.1 to about 35 wt. % ethanol, more preferably from about 79 to about 99.9 wt. % cis-HFO-1233zd and about 0.1 to about 21 wt. % ethanol, and even more preferably from about 88 to about 99.5 wt. % cis-HFO-1233zd and from about 0.5 to about 12 wt. % ethanol. In certain aspects, such cis-HFO-1233zd/ethanol compositions have a normal boiling point of about 37.4° C.±1° C. at ambient pressure.

In even further embodiments, the azeotrope-like composition comprises effective amounts of trans-HFO-1233zd and isopropanol. These binary azeotrope-like compositions may consist essentially of about 90 to about 99.9 wt. % trans-HFO-1233zd and from about 0.1 to about 10 wt. % isopropanol, more preferably from about 94 to about 99.9 wt. % trans-HFO-1233zd and about 0.1 to about 6 wt. % isopropanol, and even more preferably from about 95 to about 99.9 wt. % trans-HFO-1233zd and from about 0.1 to about 5 wt. % isopropanol. In certain aspects, such trans-HFO-1233zd/isopropanol compositions have a normal boiling point of about 17.9° C.±1° C. at ambient pressure.

In even further embodiments, the azeotrope-like composition comprises effective amounts of cis-HFO-1233zd and isopropanol. These binary azeotrope-like compositions consist essentially of about 85 to about 99.9 wt. % cis-HFO-1233zd and from about 0.1 to about 15 wt. % isopropanol, and even more preferably from about 90 to about 99.9 wt. % cis-HFO-1233zd and about 0.1 to about 10 wt. % isopropanol. In certain aspects, such cis-HFO-1233zd/isopropanol compositions have a boiling point of about 38.4±1° C., and even more preferably 38.4±0.1 at ambient pressure.

Other Information

In any of the foregoing embodiments, the second component (b) is preferably to form the compositions of the present invention. In certain preferred, but non-limiting aspects, the second component is a solvent, particularly a solvent capable to functioning in accordance with the methods and advantages discussed herein. In certain non-limiting aspects, the solvent is capable of, at least partially, solubilizing solder flux and other residues associated with print circuit board manufacture or removal of residues (such as oils and greases) from metallic or non-metallic substrates. In further embodiments, the second component is a high boiling point solvent compound.

As used herein, the term “high boiling point solvent” refers to solvent compounds having a boiling point that is greater than the boiling points of at least the first and third components and/or any azeotrope or azeotrope-like composition formed with such components discussed above in connection with the first aspect or, in connection with the second aspect, HCFO-1233zd (cis or trans) which is present, and/or any azeotrope or azeotrope-like composition formed with HCFO-1233zd and an alcohol (particularly methanol, ethanol, and/or isopropanol). that is present. In certain preferred embodiments, the “high boiling point” compounds have a boiling point that is at least 10° C. greater than, in certain preferred embodiments at least 25° C. greater than, and in certain preferred embodiments at least 50° C. or more than at least the boiling points of the first and third components and/or any azeotrope or azeotrope-like composition formed therewith, in connection with the first aspect or, in connection with the second aspect, the boiling points of HCFO-1233zd (cis or trans isomers) and/or any azeotrope or azeotrope-like composition formed with HCFO-1233zd and an alcohol (particularly methanol, ethanol, and/or isopropanol).

Many additional compounds or components, including surfactants, lubricants, stabilizers, metal passivators, corrosion inhibitors, flammability suppressants, and other compounds and/or components that modulate a particular property of the compositions (such as cost or flammability for example) may be included in the present compositions. To this end, the presence of all such compounds and components is within the broad scope of the invention. These component(s) are preferably provided in any effective amount to effectuate the advantages, methods, or uses discussed herein. In certain non-limiting embodiments, the second components (b), when present, are non-azeotropic with any of the first (a) or third (c) components present in the composition or are provided in amounts to be non-azeotropic with respect to such components.

Applicants have surprisingly and unexpectedly discovered that the preferred compositions of the invention exhibit characteristics that make them particularly desirable for a number of applications, including as solvents in a number of cleaning and other applications, especially for cleaning solder fluxes and also as aerosols and other sprayable compositions. In particular, applicants have recognized that these compositions tend to exhibit relatively low global warming potentials (“GWPs”), preferably less than about 1000, more preferably less than about 500, and even more preferably less than about 150 more close to less than 10.

In certain embodiments, the present invention includes a sprayable composition comprising the composition described herein, an active ingredient, and, optionally, inert ingredients and/or solvents and/or aerosol propellants. In a preferred embodiment, the compositions of this invention may be used as solvents in sprayable compositions, either alone or in combination with other known propellants. The solvent composition comprises, more preferably consists essentially of, and, even more preferably, consists of the compositions of the invention. In certain embodiments, the sprayable composition is an aerosol.

Suitable active materials to be sprayed include, without limitation, cosmetic materials such as deodorants, perfumes, hair sprays, cleaning solvents, lubricants, insecticides as well as medicinal materials, such as anti-asthma medications. The term medicinal materials is used herein in its broadest sense to include any and all materials which are, or at least are believed to be, effective in connection with therapeutic, diagnostic, pain relief, and similar treatments, and as such would include for example drugs and biologically active substances.

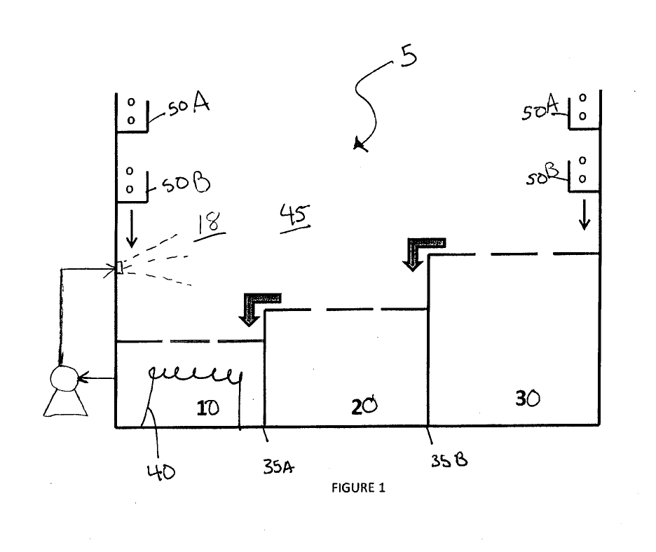

In certain preferred embodiments of the invention, the compositions described herein can be used as a solvent in cleaning various soils such as mineral oil, rosin based fluxes, silicon oils, lubricants, etc., from various substrates by wiping, vapor degreasing, or other means. In other embodiments, the compositions of the present invention are used in a vapor degreaser machine, particularly to remove solder flux and other residues from printed circuit board and/or oil- or grease-based residues from metallic or non-metallic surfaces. FIG. 1 provides a partial schematic illustration of one type of apparatus which can be used in such a process. There, a vessel 5 is divided into three sumps, 10, 20, and 30 where, at least initially, the compositions described herein are provided in all of the sumps. Each sump is separated by sump walls 35A and 35B, which are of differing sizes. As illustrated, in certain aspects, walls 35A and 35B form three sumps of differing sizes which are oriented such that fluid overflowing from sump 30 flows into sump 20 and fluid overflowing from sump 20 flows into sump 10. At least sump 10 further includes a heater element 40.

Initially, each of sumps 10, 20, and 30 all contain the same ratio of each component to the compositions described herein. Over time, however, the heater 40 in sump 10 heats the composition to a temperature above the boiling point of the first and third components in the case of the first aspect, or above component (i) in the case of the second aspect, but below the boiling point of the second component. This causes the first and third components (individually or as an azeotrope-like composition) or the component (i) if the second aspect to boil out of sump 10. These vapors eventually condense on coils 50 and return to at least one of the sumps. In certain aspects, the coils may include groups of upper coils 50A and lower coils 50B. Sump 30 continues to cascade over to sump 20 and finally to sump 10. In doing so, the concentration in the sumps will change such that sumps 20 and 30 contain more of the first and third components in the case of the first aspect or component (i) in the case of the second aspect, and the sump 10 contains more of the second component.

In such an embodiment, sump 10 provides an area where the bulk of the soil and organic cleaning agent can be washed from the substrate (e.g. printed circuit board coated with a rosin-based flux or other residue or a metallic or nonmetallic part coated with a petroleum, synthetic, or semi-synthetic based oil or grease) by either immersing into a fluid composition of the present invention and/or by placement in a spray stream 18 of the composition of the present invention, whereby the contaminated liquid drops into the sump 10 below. The substrates are then rinsed in sumps 20 and 30 to clean the parts and remove the unwanted debris. The parts may be dried by holding above one of the sumps, particularly sumps 20 or 30 and/or using evaporation in a known manner.

The parts or substrates to be cleaned may be conveyored to sump 10 and between sumps 10, 20, and 30 utilizing known conveyor or hoist means. The tanks may be part of conventional or known in-line conveyorized degreasing/defluxing equipment, separate open top defluxing tanks, or open top defluxing tanks modified to contain the cleaning and rinsing tanks or sumps.

In certain preferred aspects of the invention, the parts are dried under vapor blanket or within a vapor zone 45 that is formed (at least in part) from the portion of the first and third components (alone or as an azeotrope-like composition) in the first aspect or component (i) in the case of the second aspect boiled off from sump 10. In certain aspects, this vapor zone is free of or substantially free of the second component. As used herein, “substantially free,” when referred to the content of the second component in the vapor zone means that the amount of the second component present is sufficiently low so as to make the vapor composition nonflammable or to otherwise result in no substantial, or even more preferably no readily measurable, increase in the flammability of the vapor zone compared to flammability in the vapor zone in a case where no second component were present.

This vapor blanket is advantageous because it lessens or mitigates the flammability of the third component and/or minimizes the possibility of explosion. In certain aspects, however, it may also include one or more additional inert materials. Such materials may include, but are not limited to, one or more of nitrogen, carbon dioxide, perfluorocarbon, hydrofluorocarbon, or hydrochlorocarbon.

As illustrated, the vapor zone 45 is formed above the respective sumps 10, 20, and 30. Optional cooling coils 50 of a type known in the art (such as disclosed in U.S. Pat. No. 4,261,111, the contents of which are incorporated herein by reference in its entirety) defines the uppermost extent of the vapor zone 45 to condense vapor for return of condensate to sumps 10, 20, or 30, preferably sumps 10 or 30 and most preferably sump 30. The concentration of the first and third components (alone or as an azeotropic composition), or component (i) in the case of the second aspect, within the vapor zone 45 may be maintained at a relatively constant concentration in the vessel 5 by either returning the vapor condensate back into the sump(s) and/or pumping fluid from sump 10 to sumps 20 and/or 30 through control with a volume or level sensing transducer (not shown).

The present invention is not limited to a three sump arrangement, as discussed above and illustrated in FIG. 1. Rather, a two sump arrangement, a four sump arrangement is also contemplated. To this end, any number of sumps may be used in accordance with the teachings, objectives, and advantages herein.

The vessel 5 of FIG. 1 is depicted as an open top type of defluxer or degreaser. However, it is to be understood that the vessel 5, in its schematic form, may also characterize an in-line type of degreaser or defluxer wherein conveyor means (not shown) may be used to successively convey the parts from sumps 10 to sumps 20 and 30.

Additional features and advantages will be readily apparent to the skill artisan based on the disclosure provided herein. The following examples are provided to illustrate certain embodiments of the invention. They are not necessarily limiting to the invention. To this end, modifications of such embodiments will be readily apparent to the skilled artisan at least on the basis of the disclosure provided.

### EXAMPLES—FIRST ASPECT

### Example 1

Mixtures are prepared including 3 wt % of one of methanol, 92-96 wt % decafluoropentane (commercially available as Vertrel®), and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cello solve, diethoxyethane, dimethoxyethane, and dibutoxybutane. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 2

Mixtures are prepared including 3 wt % of one of methanol, 92-96 wt % hydrofluoroether (HFE) (commercially available as Novec® 7200), and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cellosolve, diethoxyethane, dimethoxyethane, and dibutoxybutane. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 3

Mixtures were prepared including 3 wt % of methanol and 97 wt % decafluoropentane (commercially available as VERTREL® SFR). This mixture was then combined with glycol ether 2-butoxyethanol such that the blend was provided as 80% and the glycol ether 2-butoxyethanol as 20%. Printed circuit boards were soldered with solder paste Alpha OM-338PT then cleaned in the boiling solvent for 10 min and were removed and dried. These boards were found to be clean.

### Example 4

Mixtures were prepared including 3 wt % of methanol and 97 wt % hydrofluoroether (HFE) (commercially available as Novec® 7200DA). This mixture was then combined with glycol ether 2-butoxyethanol such that the blend was provided as 80% and the glycol ether 2-butoxyethanol as 20%. Printed circuit boards were soldered with solder paste Alpha OM-338PT then cleaned in the boiling solvent for 10 min and were removed and dried. These boards were found to be clean.

### EXAMPLES—SECOND ASPECT

### Example 1

Mixtures were prepared including 3 wt % methanol, 6-25 wt % tr-1,2-dichloroethylene, and 72-92 wt % tr-1233zd. Printed circuit boards were soldered with a number of commercial solder core wires, such as, Kester 44, Alpha reliacore 15, Alpha Energized Plus and then cleaned in the boiling solvent for 10 min and was removed and dried. These cleaned boards were the visually observed for cleanliness. The boards were found to be clean.

### Example 2

Mixtures were prepared including 3 wt % methanol, 1-5 wt % butyl cellosolve, and 92-96 wt % tr-1233zd. Printed circuit boards were soldered with a number of commercial solder core wires, such as, Kester 44, Alpha reliacore 15, Alpha Energized Plus and then cleaned in the boiling solvent for 10 min and was removed and dried. These cleaned boards were the visually observed for cleanliness. The boards were found to be clean.

### Example 3

A mixture was prepared including 3 wt % methanol, 1-5 wt % d-limonene, and 92-96 wt % tr-1233zd. Printed circuit boards were soldered with a number of commercial solder core wires, such as, Kester 44, Alpha reliacore 15, Alpha Energized Plus and then cleaned in the boiling solvent for 10 min and was removed and dried. These cleaned boards were the visually observed for cleanliness. The boards were found to be clean.

### Example 4

Mixtures were prepared including 3 wt % methanol, 6-25 wt % tr-1,2-dichloroethylene, and 72-92 wt % tr-1233zd. Printed circuit boards were soldered with a number of commercial solder fluxes, such as, Kester 1544, Kester 197, Kester 186 and Hygrade 209 and then cleaned in the boiling solvent for 10 min and was removed and dried. These cleaned boards were the visually observed for cleanliness. The boards were found to be clean.

### Example 5

Mixtures is prepared including 3 wt % methanol, 70-90 wt % tr-1,2-dichloroethylene, and 10-30 wt % tr-1233zd. Printed circuit boards are soldered with a number of commercial solder fluxes, such as, Kester 1544, Kester 197, Kester 186 and Hygrade 209 and then cleaned in the boiling solvent for 10 min and is removed and dried. These cleaned boards are then visually observed for cleanliness. The boards were found to be clean.

### Example 6

Mixtures were prepared including 3 wt % methanol, 1-5 wt % butyl cellosolve, and 92-96 wt % tr-1233zd. Printed circuit boards were soldered with a number of commercial solder fluxes, such as, Kester 1544, Kester 197, Kester 186 and Hygrade 209 and then cleaned in the boiling solvent for 10 min and was removed and dried. These cleaned boards were the visually observed for cleanliness. The boards were found to be clean.

### Example 7

Mixtures were prepared including 3 wt % methanol, 1-5 wt % d-limonene, and 92-96 wt % tr-1233zd. Printed circuit boards were soldered with a number of commercial solder fluxes, such as, Kester 1544, Kester 197, Kester 186 and Hygrade 209 and then cleaned in the boiling solvent for 10 min and was removed and dried. These cleaned boards were the visually observed for cleanliness. The boards were found to be clean.

### Example 8

Mixtures were prepared including 3 wt % methanol, 5-25 wt % tr-1,2-dichloroethylene, and 72-92 wt % tr-1233zd. Printed circuit boards were soldered with a number of commercial solder pastes, such as, Indium SMQ51AC, Alpha 390, Indium NC-SMQ92J. In this case solder pastes were applied using squeegee through a stencil on the board and then heated to 450 F in a hot air knife. They were then cleaned in the boiling solvent for 10 min and was removed and dried. These cleaned boards were the visually observed for cleanliness. The boards were found to be clean.

### Example 9

For each of the following compositions, an aerosol valve is crimped into place and HFC-134a is added through the valve to achieve a pressure in the can of about 20 PSIG. Printed circuit boards are soldered with Kester 1544 flux, Kester 44, Alpha Reliacore 15 and Alpha Energized Plus solder core wires. The mixture is then sprayed onto surface to demonstrate whether the mixture is useful as an aerosol. Optionally, the aerosols have a different co-aerosol agent or no co-aerosol agent, and optionally have at least one active ingredient selected from the group consisting of deodorants, perfumes, hair sprays, cleaning solvents, lubricants, insecticides, and medicinal materials.

| Solvent | Compositions |
|---|---|
| tr-1233zd/methanol/tr-1,2-dichloroethylene | 47/3/50 |
| tr-1233zd/methanol/butyl cellosolve | 92/3/5 |
| tr-1233zd/methanol/d-limonene | 92/3/5 |

### Example 10

Mixtures are prepared including 3 wt % of one of methanol, ethanol, or isopropanol, 92-96 wt % tr-1233zd, and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cello solve, diethoxyethane, dimethoxyethane, and dibutoxybutane. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 11

Mixtures are prepared including 6-25 wt % tr-1,2-dichloroethylene and 75-94 wt % tr-1233zd. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 12

Mixtures are prepared including 1-5 wt % butyl cellosolve and 95-99 wt % tr-1233zd. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 13

A mixture is prepared including 1-5 wt % d-limonene and 95-99 wt % tr-1233zd. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 14

A mixture is prepared including 3 wt % methanol, 1-5 wt % pinene, and 92-96 wt % tr-1233zd. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 15

A mixture is prepared including 1-5 wt % pinene and 95-99 wt % tr-1233zd. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 16

Mixtures are prepared including 95-99 wt % tr-1233zd, and 1-5 wt % of a glycol ether selected from 2-ethoxyethanol, 2-methoxyethanol, 2-propxyethanol, 2-phenoxyethanol, 2-benzoxy ethanol, methyl carbitol, carbitol cellosolve, diethoxyethane, dimethoxyethane, and dibutoxybutane. Printed circuit boards are soldered with a number of commercial solder core wires, such as, Kester 44, Alpha reliacore 15, Alpha Energized Plus and then cleaned in the boiling solvent for 10 min and are removed and dried. These cleaned boards are found to be clean.

### Example 17

For the following compositions, an aerosol valve was crimped into place and HFO-1234ze was added through the valve to achieve a pressure in the can of about 20 PSIG. Printed circuit boards were soldered with Kester 1544 flux, Kester 44, Alpha Reliacore 15 and Alpha Energized Plus solder core wires. The mixture was then sprayed onto surface to demonstrate whether the mixture was useful as an aerosol. Optionally, the aerosols had a different co-aerosol agent or no co-aerosol agent, and optionally had at least one active ingredient selected from the group consisting of deodorants, perfumes, hair sprays, cleaning solvents, lubricants, insecticides, and medicinal materials.

| Solvent | Compositions, wt % |
|---|---|
| tr-1233zd/methanol/tr-1,2-dichloroethylene | 47/3/50 |

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for removing residual soils or surface contamination from a part comprising:
A) immersing the part in a liquid solvent composition comprising (a) a first component comprising an alcohol selected from the group consisting of methanol, ethanol and isopropanol, (b) a second component selected from the group consisting of a glycol ether, a terpene, a halogenated hydrocarbon, and combinations thereof, and (c) a third component selected from the group consisting of a hydrohaloether, a decahalopentane, and combinations thereof;
B) vaporizing a portion of the liquid solvent composition to form a vapor space comprising a vaporized portion of component (a) and (c) and amounts of component (b) sufficiently low such that a flammability-suppression blank exists in said vapor space; and
C) drying the part within the flammability-suppression blanket.

2. The method of claim 1, wherein component (c) has a boiling point that is at least 10° C. higher than components (a) and (b) or any azeotrope or azeotrope-like composition formed between components (a) and (b).

3. The method of claim 1 wherein component (c) has a boiling point that is at least 25° C. higher than components (a) and (b) or any azeotrope or azeotrope-like composition formed between components (a) and (b).

4. The method of claim 1 wherein component (c) has a boiling point that is at least 50° C. higher than components (a) and (b) or any azeotrope or azeotrope-like composition formed between components (a) and (c).

5. A method for removing residual soils or surface contamination from a part comprising:
A) immersing the part in a liquid solvent composition comprising (i) a first component comprising 1-chloro-3,3,3-trifluorpropene, (iii) a second component selected from the group consisting of a glycol ether, a terpene, a halogenated hydrocarbon, and combinations thereof, and optionally (iii) a third component selected from the group consisting of a hydrohaloether, a decahalopentane, and combinations thereof;
B) vaporizing a portion of the liquid solvent composition to form a vapor space comprising a vaporized portion of component (i) and component (iii), if present, and amounts of component (ii) sufficiently low such that a flammability-suppression blank exists in said vapor space; and
C) drying the part within the flammability-suppression blanket.

6. The method of claim 5, wherein component (ii) has a boiling point that is at least 10° C. higher than the boiling point of components (i) and (iii) if present.

7. The method of claim 5, wherein component (ii) has a boiling point that is at least 25° C. higher than the boiling point of components (i) and (iii) if present.

8. The method of claim 5, wherein component (ii) has a boiling point that is at least 50° C. higher than the boiling point of components (i) and (iii) if present.

9. A solvent composition comprising
(a) a first component comprising an alcohol selected from the group consisting of methanol, ethanol and isopropanol,
(b) a second component selected from the group consisting of a glycol ether, a terpene, a halogenated hydrocarbon, and combinations thereof,
(c) a third component selected from the group consisting of a hydrohaloether, a decahalopentane, and combinations thereof, wherein the second and third components are not the same.

10. The composition of claim 9, wherein the third component is provided in an amount effective to form an azeotrope or azeotrope-like composition with at least one alcohol of the first component.

11. The composition of claim 9, wherein the second component comprises a halogenated hydrocarbon.

12. The composition of claim 11, wherein the halogenated hydrocarbon is selected from the group consisting of trans-1,2-dichloroethylene, perchloroethylene, trichloroethylene, and combinations thereof.

13. The composition of claim 9, wherein the second component comprises a glycol ether.

14. The composition of claim 13, wherein the glycol ether is selected from the group consisting of ethylene glycol monobutyl ether, 2-ethoxyethanol, 2-methoxyethanol, 2-propxyethanol, 2-phenoxyethanol, 2-benzoxy ethanol, methyl carbitol, carbitol cello solve, diethoxyethane, dimethoxyethane, and dibutoxybutane.

15. The composition of claim 9, wherein the second component comprises a terpene.

16. The composition of claim 15, wherein the terpene comprises d-Limonene and/or pinene.

17. The composition of claim 9, wherein the third component comprises a the hydrofluoroether CH₂OCF₂CF₂CF₂CF₃.

18. The composition of claim 17, wherein the hydrohaloether is provided in an amount from about 50 weight percent to about 99 weight percent.

19. The composition of claim 9, wherein the third component comprises decafluoropentane.

20. A sprayable composition comprising a material to be sprayed with a propellant and the solvent comprising of the composition of claim 1.
